(19) United States
(12) Patent Application Publication
(10) Pub. No.: US 2016/0020002 A1
(43) Pub. Date: Jan. 21, 2016

(54) CABLE HAVING A SIMPLIFIED CONFIGURATION TO REALIZE SHIELDING EFFECT

(71) Applicant: DONGGUAN XUNTAO ELECTRONIC CO., LTD., Dongguan City (CN)

(72) Inventor: YUN FENG, Dongguan City (CN)

(21) Appl. No.: 14/499,042

(22) Filed: Sep. 26, 2014

(30) Foreign Application Priority Data
Jul. 18, 2014 (CN) 201420401613.1

(51) Int. Cl. H01B 9/02; H01B 7/30

(52) U.S. Cl. CPC H01B 9/024; H01B 7/30

(57) ABSTRACT

A cable includes at least one differential pair wire, at least one power wire, an outer shielding layer enclosing on the differential pair wire and the power wire and an insulative outer jacket wrapped on the outer shielding layer. Each differential pair wire has a pair of signal wires separated from each other, two insulating covers covering on corresponding signal wires, and a first inner shielding layer enclosing on the insulating covers. The power wire has a power conductor, an insulator enclosing on the power conductor and a second inner shielding layer coated on the insulator. The first inner shielding layer is mechanically and electrically connected with the second inner shielding layer to achieve signal grounding.

### BACKGROUND OF THE INVENTION

1. Field of the Invention

The present invention relates to a cable, and more particularly, to a cable with high frequency electrical performance. A simplified configuration to realize shielding effect

2. Description of Related Art

With development of high definition (HD) technology in the field of consumer electronics and display, cables compatible with high-definition multimedia interface (HDMI) technology for connecting HD equipment are constantly improved. China Patent issued No. 201160017Y, to Lu on Dec. 3, 2008, discloses an HDMI transmission cable, including a control signal wire, a plurality of differential pair wires, an aluminum foil layer, a metal-braided layer and an outer sheath. Each differential pair wire comprises two differential signal wires, a grounding bare wire and a metal shielding tape, the metal shielding tape is enclosing the differential signal wires and the grounding bare wire. The differential pair wires and the control signal wire can be clad in the aluminum foil layer, and the metal-braided layer is wrapping on the aluminum foil layer, then the outer sheath is enclosing on the metal-braided layer. Thus the HDMI transmission cable has a complicated structure and a miscellaneous manufacture procedure, and it's difficult to make cost down.

As discussed above, an improved cable overcoming the shortages of existing technology is desired.

### BRIEF SUMMARY OF THE INVENTION

The present invention provides a cable including at least one differential pair wire, at least one power wire, an outer shielding layer enclosing on the differential pair wire and the power wire and an insulative outer jacket wrapped on the outer shielding layer. Each differential pair wire has a pair of signal wires separated from each other, two insulating covers covering on corresponding signal wires, and a first inner shielding layer enclosing on the insulating covers. The power wire has a power conductor, an insulator enclosing on the power conductor and a second inner shielding layer coated on the insulator. The first inner shielding layer is mechanically and electrically connected with the second inner shielding layer to achieve signal grounding.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

The components in the drawing are not necessarily drawn to scale, the emphasis instead being placed upon clearly illustrating the principles of the described embodiments. In the drawings, reference numerals designate corresponding parts throughout various views, and all the views are schematic.

FIG. 1 is a cross-section view of a cable in accordance with a first embodiment of the present invention;

FIG. 2 is a cross-section view of a cable in accordance with a second embodiment of the present invention;

FIG. 3 is a cross-section view of a cable in accordance with a third embodiment of the present invention;

FIG. 4 is a cross-section view of a cable in accordance with a fourth embodiment of the present invention; and

FIG. 5 is a cross-section view of a cable in accordance with a fifth embodiment of the present invention.

### DETAILED DESCRIPTION OF THE PREFERRED EMBODIMENT

Reference will now be made to the drawing figures to describe the embodiments of the present invention in detail. In the following description, the same drawing reference numerals are used for the same elements in different drawings.

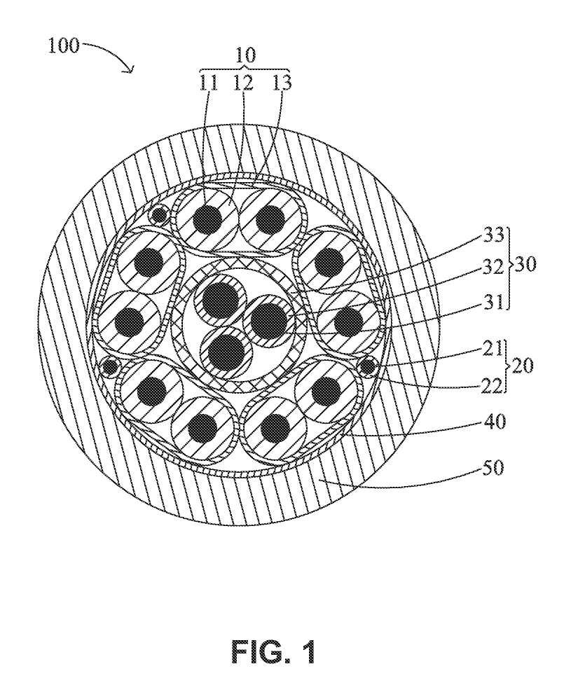

FIG. 1 is a cross-sectional view showing the configuration of a cable 100 according to a first embodiment of the present invention. The cable 100 has a circular configuration to be compatible with the USB 2.0 standard or USB 3.0 standard. According to the first illustrated embodiment of the present invention, the cable 100 includes five differential pair wires 10, three control wires 20, three power wires 30, an outer shielding layer 40, and an insulative outer jacket 50 enclosing on the outer shielding layer 40. The power wires 30 are located in the middle of a cross-section view of the cable 100.

Each differential pair wire 10 comprises a pair of signal wires 11 separated from each other, two insulating covers 12 covering on corresponding signal wires 11, and a first inner shielding layer 13 enclosing on the insulating covers 12. Each signal wire 11 which is used in the differential pair wires 10 is preferably an American Wire Gauge (AWG) wire of about 30. The two insulating covers 12 of each differential pair wire 10 are manufactured separately, and are distributed in parallel or twisted with each other. The material for the insulating covers 12 is polyethylene (PE) or Fluorinated Ethylene Propylene (FEP). The first inner shielding layer 13 is an aluminum foil Mylar with functions of shielding and conducting electricity, and includes a conductive surface back to corresponding signal wires 11 to mechanically and electrically connect with the outer shielding layer 40. The first inner shielding layer 13 can also be formed by a metal-braided tape or conductive polymer material.

The control wires 20 are configured as reserved function wires or detection wires for detection signal transmission. Each control wire 20 includes a control conductor 21 and an insulator 22 coated on the control conductor 21. The three control wires 20 are spaced apart from each other by at least one differential pair wire 10.

The five differential pair wires 10 are surrounding the power wires 30 symmetrically and disposed adjacent to the power wires 30 intimately. The three power wires 30 are twisted together, and each power wire 30 includes a power conductor 31 and an insulator 32 enclosing on the power conductor 31. Each power conductor 31 has a wire size of AWG 28, and is thicker than the signal wire 11 and the control conductor 21. A second inner shielding layer 33 is coated on the three power wires 30 to achieve an effect of power grounding and current shielding, and to reduce the electromagnetic disturbance that current of the power wires 30 exerting to the differential pair wires 10, therefore high-frequency transmission performance of the cable 100 can be improved. The second inner shielding layer 33 can be a metallic braiding layer, and also can be a metal winding layer with coverage of more than 95%.

The first inner shielding layers 13 are mechanically and electrically connected with the second inner shielding layer 33, and each differential pair wire 10 itself can realize an effect of signal grounding, moreover the five differential pair wires 10 therebetween can achieve an effect of signal grounding by the first inner shielding layers 13 and the second inner shielding layer 33. As a result, each differential pair wire 10 of the cable 100 does not need to be provided with a grounding wire therein, signal integrity of the cable 100 can also be ensured. The cable 100 has a simplified configuration, and manufacturing costs of the cable 100 can be reduced effectively.

The outer shielding layer 40 can be made of a metallic braiding layer or a conductive polymer materials, and can also be an aluminum foil Mylar or an aluminum foil having a conductive surface facing to the power wires 30. The outer shielding layer 40 is enclosing on the five differential pair wires 10 and the three control wires 20, and mechanically and electrically connected with the first inner shielding layers 13, thus an electrical connection between the first inner shielding layer 13, the second inner shielding layer 33 and the outer shielding layer 40 is established, and the differential pair wires 10 can obtain an improved grounding effect, thereupon the cable 100 can achieve a better shielding effect.

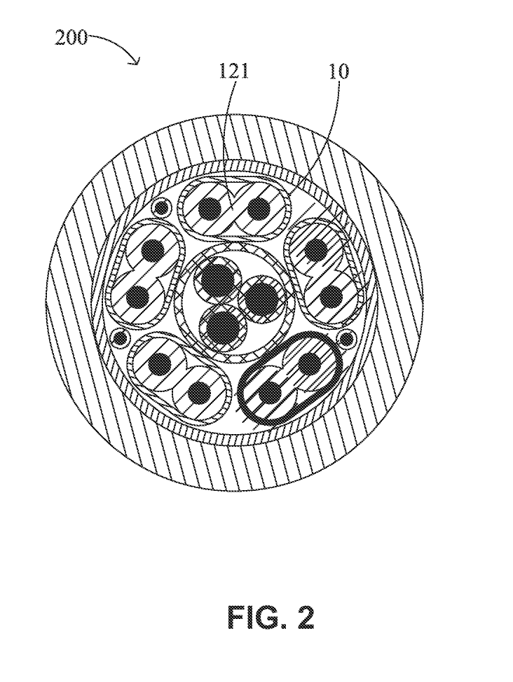

Referring to FIG. 2, according to a second embodiment of the present invention, a cable 200 is similar to the cable 100 in accordance of the first embodiment, the only difference is that an insulating cover 121 of each differential pair wire 10 is of a unitary configuration, thus each differential pair wire 10 can be extruded integratively, and a distance between the two signal wires 11 is easy to control, the cable 200 can be made expediently with lower cost.

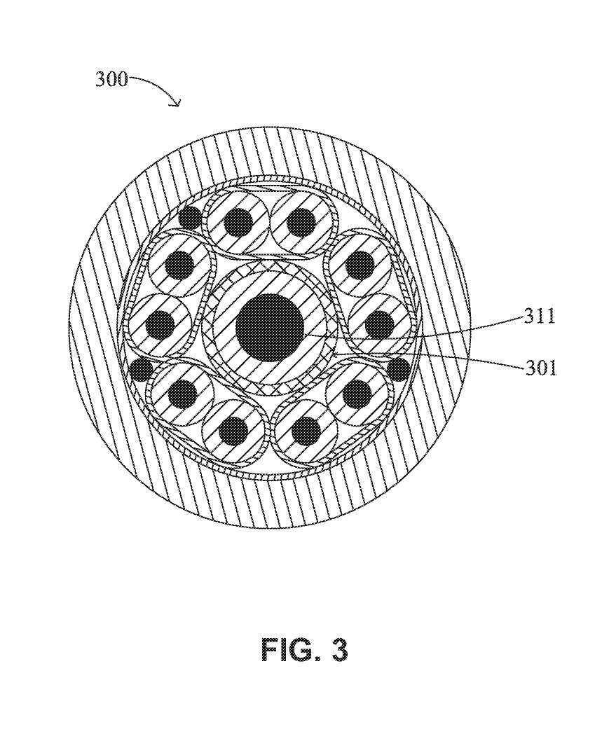

Referring to FIG. 3, a cable 300 according to a third embodiment of the present invention, has a difference between the cable 100 in the first embodiment, the cable 300 defines only one power wire 301, and a power conductor 311 of the power wire 301 has a wire size of AWG 22.

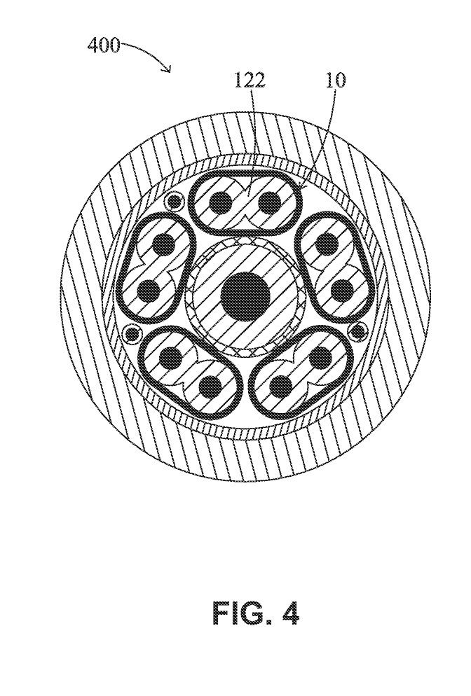

Referring to FIG. 4, a cable 400 according to a fourth embodiment of the present invention, has a difference between the cable 300 in the third embodiment, each differential pair wire 10 of the cable 400 has a unitary insulating cover 122.

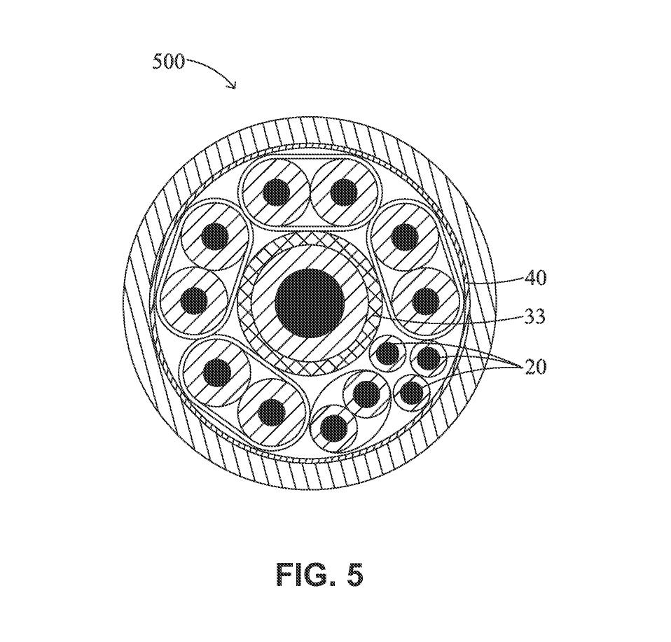

Referring to FIG. 5, a cable 500 according to a fifth embodiment of the present invention, has a difference between the cable 300 in the third embodiment, three control wires 20 are gathered together, further located between two neighboring differential pair wires 10, the second inner shielding layer 33 and the outer shielding layer 40.

It is to be understood, however, that even though numerous characteristics and advantages of preferred and exemplary embodiments have been set out in the foregoing description, together with details of the structures and functions of the embodiments, the disclosure is illustrative only; and that changes may be made in detail within the principles of present disclosure to the full extent indicated by the broadest general meaning of the terms in which the appended claims are expressed.

What is claimed is:

1. A cable, comprising:
at least one differential pair wire having a pair of signal wires separated from each other, two insulating covers covering on corresponding signal wires, and a first inner shielding layer enclosing on the insulating covers;
at least one power wire having a power conductor, an insulator enclosing on the power conductor and a second inner shielding layer coated on the insulator;
an outer shielding layer enclosing on the differential pair wire and the power wire; and
an insulative outer jacket wrapped on the outer shielding layer; wherein
the first inner shielding layer is mechanically and electrically connected with the second inner shielding layer to achieve signal grounding.

2. The cable as claimed in claim 1, wherein the first inner shielding layer is mechanically and electrically connected with the outer shielding layer.

3. The cable as claimed in claim 1, wherein the first inner shielding layer is formed by a metal-braided tape, or conductive polymer material, or an aluminum foil Mylar with a conductive surface back to the signal wires.

4. The cable as claimed in claim 1, wherein the second inner shielding layer is a metallic braiding layer or a metal winding layer.

5. The cable as claimed in claim 1, wherein the outer shielding layer is made of a metallic braiding layer or a conductive polymer materials, or an aluminum foil Mylar or an aluminum foil having a conductive surface facing to the power wire.

6. The cable as claimed in claim 1, further comprising at least one control wire, wherein the control wire is configured as a reserved function wire or a detection wire for detection signal transmission.

7. The cable as claimed in claim 6, wherein the control wire includes a control conductor and an insulator coated on the control conductor, and the control wire is located among two neighboring differential pair wires and the outer shielding layer.

8. The cable as claimed in claim 1, wherein the cable has a plurality of differential pair wires surrounding the power wire symmetrically and disposed adjacent to the power wire intimately.

9. The cable as claimed in claim 8, wherein the signal wire includes a wire size of American Wire Gauge (AWG) 30.

10. The cable as claimed in claim 1, wherein the cable has a plurality of power wires twisted together, and the power wires are wrapped with the second inner shielding layer simultaneously, the power conductor of each power wire has a wire size of AWG 28.

11. The cable as claimed in claim 1, wherein the cable defines only one power wire having a power conductor with a wire size of AWG 22.

12. The cable as claimed in claim 1, wherein the cable has a circular configuration, two insulating covers of each differential pair wire are formed by a unitary configuration.

13. The cable as claimed in claim 1, further comprising a plurality of control wires gathered together, wherein the control wires are used as reserved function wires or detection wires for detection signal transmission, and the control wires are located among two neighboring differential pair wires, the second inner shielding layer and the outer shielding layer, each control wire includes a control conductor and an insulator coated on the control conductor.

14. A cable comprising:
a plurality of differential pair wires, and each having a pair of signal wires separated from each other, an insulating cover covering on corresponding two signal wires, and a first inner shielding layer enclosing on the insulating cover;
a power wire in the middle of the cable surrounded by the differential pair wires intimately, and having a power conductor, an insulator enclosing on the power conductor and a second inner shielding layer coated on the insulator;
an outer shielding layer enclosing on the differential pair wires and the power wire; and
an insulative outer jacket wrapped on the outer shielding layer; wherein
the first inner shielding layer is mechanically and electrically connected with the second inner shielding layer to achieve signal grounding.

15. The cable as claimed in claim 14, wherein the first inner shielding layer is an aluminum foil Mylar with functions of shielding and conductive, and has a conductive surface back to corresponding signal wires to mechanically and electrically connect with the outer shielding layer.

16. The cable as claimed in claim 15, wherein the outer shielding layer is made of a metallic braiding layer or a conductive polymer materials, or an aluminum foil Mylar or an aluminum foil having a conductive surface facing to the power wire.

17. The cable as claimed in claim 15, wherein the insulating cover is formed by a unitary configuration.

18. The cable as claimed in claim 16, further comprising a plurality of control wires, wherein the control wires are dispersed in corresponding gaps between two neighboring differential pair wires.

19. The cable as claimed in claim 16, further comprising a plurality of control wires, wherein the control wires are gathered together and located among two neighboring differential pair wires, the second inner shielding layer and the outer shielding layer.

20. A cable comprising:
an inner power wire and an outer shielding layer coaxially radially sandwiching a plurality of differential pair wires therebetween;
an insulative outer jacket wrapped on the outer shielding layer;
each differential pair wire defining a pair of signal wires separated from each other, two insulating covers covering on corresponding signal wires, and a first inner shielding layer enclosing on the insulating covers, the first inner shielding layer having a conductive surface back to the inner power wire; and
the inner power wire including a second inner shielding layer being contacted with the first inner shielding layer, the outer shielding layer having an inner conductive surface facing to the inner power wire and being electrically connected with the first inner shielding layer.
